(19) United States
(12) Patent Application Publication
(10) Pub. No.: US 2015/0264265 A1
(43) Pub. Date: Sep. 17, 2015

(54) CAMERA MODULE

(71) Applicant: Kabushiki Kaisha Toshiba, Minato-ku (JP)

(72) Inventors: Katsuo IWATA, Yokohama (JP); Takayuki Ogasahara, Yokohama (JP); Kazuhiro Nagata, Yokohama (JP); Ninao Sato, Mitaka (JP)

(73) Assignee: Kabushiki Kaisha Toshiba, Minato-ku (JP)

(21) Appl. No.: 14/624,732

(22) Filed: Feb. 18, 2015

(30) Foreign Application Priority Data
Mar. 14, 2014 (JP) 2014-051713

(51) Int. Cl. H04N 5/232; H04N 5/225; G02B 27/00

(52) U.S. Cl. CPC H04N 5/23267; G02B 27/0025; H04N 5/2253; H04N 5/2254

(57) ABSTRACT

Certain embodiments provide a camera module including a blur correcting lens, a lens holder, a solid state imaging chip, and a distortion correction processing chip. The lens holder is arranged on a mounting substrate and includes the blur correcting lens inside the lens holder. The solid state imaging chip is arranged on the mounting substrate so as to be covered by the lens holder, and includes a logic circuit and a pixel unit having a plurality of pixels. The distortion correction processing chip is arranged on the mounting substrate inside the lens holder, and corrects an image signal output from the solid state imaging chip to correct distortion of the image formed by the image signal.

### CROSS REFERENCE TO RELATED APPLICATIONS

This application is based upon and claims the benefit of priority from the prior Japanese Patent Application No. 2014-051713 filed in Japan on Mar. 14, 2014; the entire contents of which are incorporated herein by reference.

### FIELD

Embodiments described herein relate generally a camera module.

### BACKGROUND

A small camera module mounted on mobile phones or the like, for example, may include a solid state imaging device and a lens holder. The lens holder includes a lens arranged inside the lens holder and configured to cover the solid state imaging device. Such a camera module can focus light reflected from an object onto a solid state imaging device using a lens to form an image of the object.

Because of aberration of the lens, the image formed by the lens includes blurs and distortions. The image formed by focusing light on the solid state imaging device, therefore, includes blurs and distortions, causing deterioration in quality of the image output from the camera module. To improve the quality of the output image, it is necessary to suppress the aberration of the lens as much as possible. To suppress the aberration of the lens, a group of lenses formed by a combination of lenses needs to be applied to the camera module. However, the necessary number of lenses increases as the aberration is further suppressed. Suppressing the aberration of the lens, therefore, leads to a problem that the size of the camera module is enlarged when the quality of the output image output from the camera module is further improved.

### BRIEF DESCRIPTION OF THE DRAWINGS

FIG. 1 is a sectional view illustrating a camera module according to a first embodiment;

FIG. 2 is a sectional view of the camera module cut along a dashed line X-X′ of FIG. 1;

FIG. 3 is a block diagram illustrating the camera module of FIG. 1;

FIG. 4A is a schematic view illustrating an exemplary image in which distortion aberration has occurred;

FIG. 4B is a graph illustrating a position from the center of the pixel as a function of an aberration quantity included in an image signal obtained from each pixel and constituting an image in which distortion aberration has occurred;

FIG. 4C is a graph illustrating the position from the center of the pixel as a function of the aberration quantity included in the image signal obtained from each pixel and constituting an image after the distortion aberration has been corrected;

FIG. 4D is a schematic view of an exemplary image in which the distortion aberration has been corrected;

FIG. 5A is a schematic view illustrating an exemplary image in which magnification chromatic aberration has occurred;

FIG. 5B is a graph illustrating the position from the center of the pixel as a function of the aberration quantity included in the image signal obtained from each pixel and constituting an image in which the magnification chromatic aberration has occurred;

FIG. 5C is a graph illustrating the position from the center of the pixel as a function of then aberration quantity included in the image signal obtained from each pixel and constituting an image after the magnification chromatic aberration has been corrected;

FIG. 5D is a schematic view of an exemplary image in which the magnification chromatic aberration has been corrected;

FIG. 6A is a schematic view illustrating an exemplary image in which the distortion aberration and the magnification chromatic aberration have occurred;

FIG. 6B is a graph illustrating the position from the center of the pixel as a function of the aberration quantity included in the image signal obtained from each pixel and constituting an image in which the distortion aberration and the magnification chromatic aberration have occurred;

FIG. 6C is a graph illustrating the position from the center of the pixel as a function of the aberration quantity included in the image signal obtained from each pixel and constituting an image after the distortion aberration and the magnification chromatic aberration have been corrected;

FIG. 6D is a schematic view of an exemplary image in which the distortion aberration and the magnification chromatic aberration have been corrected;

FIG. 7 is a block diagram of a logic circuit including a distortion correction processing circuit;

FIG. 8 is a sectional view illustrating a camera module according to a second embodiment;

FIG. 9 is a sectional view illustrating a camera module according to a third embodiment; and

FIG. 10 is a sectional view illustrating a camera module according to a fourth embodiment.

### DESCRIPTION OF THE EMBODIMENTS

Certain embodiments provide a camera module including a blur correcting lens, a lens holder, a solid state imaging chip, and a distortion correction processing chip. The lens holder is arranged on a mounting substrate and includes the blur correcting lens inside the lens holder. The solid state imaging chip is arranged on the mounting substrate so as to be covered by the lens holder, and includes a logic circuit and a pixel unit having a plurality of pixels. The distortion correction processing chip is arranged on the mounting substrate inside the lens holder, and corrects an image signal output from the solid state imaging chip to correct distortion of the image formed by the image signal.

A camera module according to embodiments will be described in detail below.

### First Embodiment

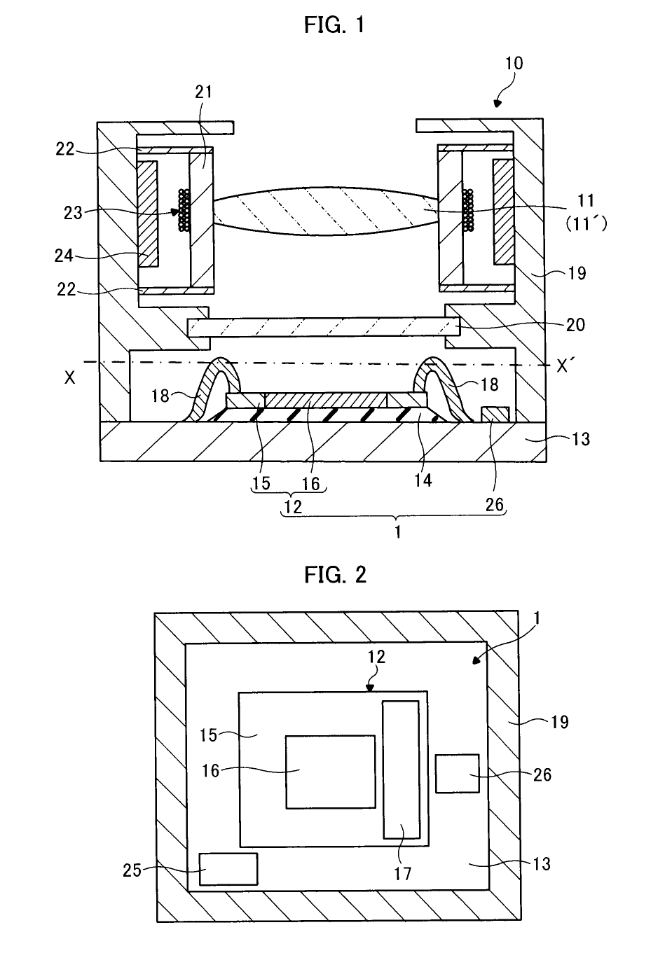

FIG. 1 is a sectional view illustrating a camera module according to a first embodiment. A camera module 10 illustrated in FIG. 1 includes a solid state imaging device 1 and a lens holder 19 having a lens 11 arranged inside the lens holder 19. The camera module 10 focuses light reflected from an object through the lens 11 onto the solid state imaging device 1, and forms an image of the object according to an image signal output from the solid state imaging device 1.

The solid state imaging device 1 of the camera module 10 includes a solid state imaging chip 12 and a distortion correction processing chip 26 on a substrate 13. The substrate 13 is a mounting substrate which is, for example, a printed substrate.

The solid state imaging chip 12 includes a semiconductor substrate 15 that is, for example, a CMOS sensor unit made of silicon or the like, a pixel unit 16 provided on a part of the surface of the semiconductor substrate 15, and a logic circuit 17.

The pixel unit 16 is, for example, a CMOS sensor formed by a plurality of pixels arranged two dimensionally in a grid-like manner.

FIG. 2 is a sectional view of the camera module 10 along a dashed line X-X′ of FIG. 1. As illustrated in FIG. 2, in the solid state imaging device 1, the logic circuit 17 is provided around the pixel unit on a part of the surface of the semiconductor substrate 15 included in the solid state imaging chip 12. The logic circuit 17 includes a correction processing circuit of pixel characteristics variation and a blur correction processing circuit.

The correction processing circuit of pixel characteristics variation corrects an image signal obtained from the pixel unit 16 so as to suppress variation in characteristics of each pixel provided in the pixel unit 16. Specifically, the correction processing circuit performs various types of processing including correction of defective pixels to supply desired luminance to a defective pixel, black level correction to remove noise according to dark current of each pixel, shading correction to suppress variation of luminance of a plurality of pixels, noise reduction, and so on.

The blur correction processing circuit corrects occurrence of blurs in the image formed by an image signal output from the pixel unit 16 of the solid state imaging chip 12 due to the aberration of the collecting lens 11. Specifically, the correction processing circuit restores resolution by, for example, correcting spherical aberration, coma aberration, astigmatism, and field curvature of the lens 11.

The spherical aberration, the coma aberration, the astigmatism, and the field curvature may also be corrected by applying a blur correcting lens 11′ for correcting such aberration while collecting light as a lens. When the blur correcting lens 11′ is used, the blur correction processing circuit may not be necessary, but is preferably provided. When one of the spherical aberration, the coma aberration, the astigmatism, and the field curvature is corrected by the blur correction lens 11′, the blur correction processing circuit may correct aberration that has not been corrected by the lens 11′ among the spherical aberration, the coma aberration, the astigmatism, and the field curvature.

Referring to FIG. 1, the solid state imaging chip 12 is electrically connected to the substrate 13 via a connecting conductor such as a wire 18, by means of connecting wiring (not illustrated) on the substrate 13 with wiring (not illustrated) on the semiconductor substrate 15 constituting the solid state imaging chip 12.

A lens holder 19 made of, for example, a light shielding resin is arranged on the surface of the substrate 13 where the solid state imaging chip 12 is arranged. The lens holder 19 is in tubular shape and arranged on the surface of the substrate 13 so as to cover the solid state imaging chip 12.

An infrared ray blocking filter 20 is arranged at a part of the inner side of the lens holder 19 to block an infrared component of light, which has been incident on the camera module 10, and allow transmission of light components other than the infrared component

A lens barrel 21 made of, for example, a light shielding resin is arranged above the infrared ray blocking filter 20 on the inner side of such a lens holder 19. The lens barrel 21 is in tubular shape and arranged inside the lens holder 19, while being supported by an elastic body, such as a spring 22.

A lens 11 is arranged in the lens barrel 21 to focus light onto the pixel unit 16 of the above-mentioned solid state imaging chip 12. The blur correcting lens 11′ may be provided in the lens barrel 21 to focus light and correct four types of aberration including the spherical aberration, the coma aberration, the astigmatism, and the field curvature among Zeidel's five types of aberration, while focusing light. Thus, the lens 11 or 11′ alone is applied as a lens to be arranged in the lens barrel 21. In the lens barrel 21, there is no lens for correcting the distortion aberration and the magnification chromatic aberration. The lens 11 (11′), therefore, includes the distortion aberration and the magnification chromatic aberration as the distortion characteristics causing distortion in the image formed according to the image signal output at least from the solid state imaging chip 12.

A lens driving unit formed by, for example, a coil 23 that moves the lens 11 in upward and downward directions is provided on the outer periphery of the lens barrel 21. Meanwhile, a yoke 24 that generates a magnetic field in a predetermined direction is provided on the inner periphery of the lens holder 19. Lorentz force is generated in the coil 23 by the magnetic field generated by the yoke 24 and an electric current flowing through the coil 23. By means of the Lorentz force, the lens barrel 21 including the coil 23 can move in a direction opposite to the elastic force of the spring 22.

As illustrated in FIG. 2, an auto focus (AF) driver 25 acting as a driver that supplies an electric current to the coil 23 is arranged in, for example, a peripheral area of the solid state imaging chip 12 on the surface of the substrate 13 surrounded by the lens holder 19.

In such a camera module 10, the solid state imaging device 1 includes the distortion correction processing chip 26 arranged on the surface of the substrate 13 surrounded by the lens holder 19 (FIGS. 1 and 2). The distortion correction processing chip is arranged in an unused area of the surface of the substrate 13 around the solid state imaging chip 12. The distortion correction processing chip 26 corrects distortion of the image formed according to the image signal output from the pixel unit 16 of the solid state imaging chip 12. Specifically, the correction processing chip 26 corrects the distortion aberration and the magnification chromatic aberration of the lens 11.

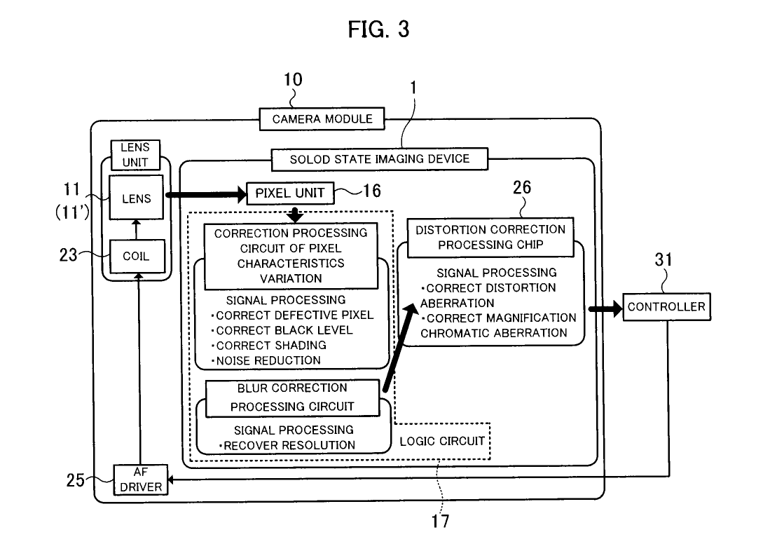

FIG. 3 is a block diagram illustrating the camera module 10 described above. An operation of the camera module 10 will be described below by referring to FIG. 3.

As illustrated in FIG. 3, the lens 11 of the lens unit first receives incident light after it has been reflected from an object. The incident light is then collected by the pixel unit 16 of the solid state imaging device 1.

When the pixel unit 16 is irradiated with the incident light, each pixel arranged in the pixel unit 16 generates a pixel signal according to the received incident light. The image signal generated in the pixel unit 16 is input to the logic circuit 17 that includes the correction processing circuit of pixel characteristics variation and the blur correction processing circuit.

Upon input of the image signal into the correction processing circuit of pixel characteristics variation of the logic circuit 17, the correction processing is performed on the image signal so as to suppress the variation of characteristics of each pixel arranged in the pixel unit 16.

Upon input of the image signal into the blur correction processing circuit of the logic circuit 17, the correction processing is performed on the image signal so as to correct blurs of the image formed according to the image signal output from the pixel unit 16.

Subsequent to such correction processing in the logic circuit 17, the image signal is input to the distortion correction processing chip 26.

Upon input of the image signal into the distortion correction processing chip 26, the correction processing is performed on the image signal so as to correct distortion (the distortion aberration and the magnification chromatic aberration) of the image formed according to the image signal output from the pixel unit 16.

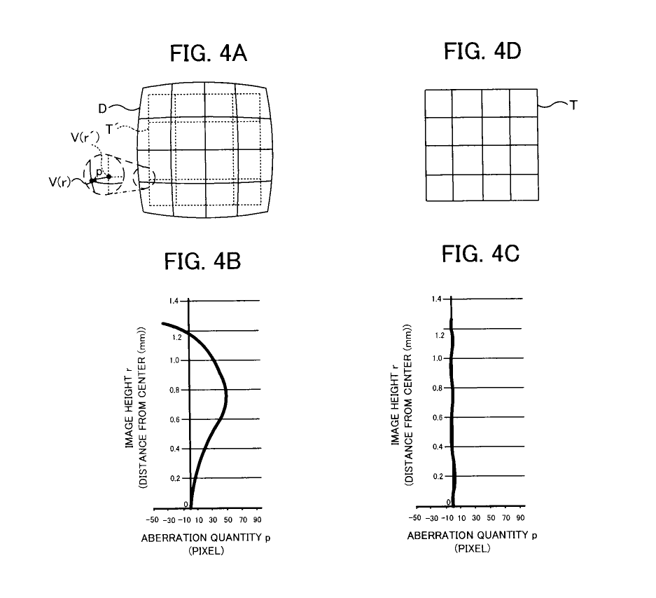

The distortion aberration and the correction of the distortion aberration will be described by referring to FIGS. 4A to 4D. FIG. 4A is a schematic view illustrating an exemplary image in which distortion aberration has occurred. FIG. 4B is a graph illustrating a position from the center of the pixel as a function of an aberration quantity included in an image signal obtained from each pixel and constituting an image having distortion aberration occurred therein. FIG. 4C is a graph illustrating the position from the center of the pixel as a function of the aberration quantity included in the image signal obtained from each pixel and constituting an image after the distortion aberration has been corrected. FIG. 4D is a schematic view of an exemplary image in which the distortion aberration has been corrected.

When the distortion aberration occurs in the image according to the image signal output from the pixel unit 16, the image is distorted in barrel shape, as indicated by a solid line D of FIG. 4A, instead of an ideal image that reproduces the object, as indicated by a dotted line T′ of FIG. 4A.

The image indicated by the solid line D in FIG. 4A is formed as a result of the image signal, which has been obtained from the pixel provided at a position corresponding to the image height r (a position at distance r from the center of the pixel unit 16), including aberration of an aberration quantity p, as illustrated in FIG. 4B. That is, in an ideal case where no distortion aberration occurs, as illustrated in FIG. 4A, it is assumed that an image signal V (r′) is obtained from the pixel provided at a position corresponding to the image height r′. Actually, however, the resulting image signal is an image signal V (r) obtained from the pixel provided at the position corresponding to the image height r, which has been shifted by the aberration quantity p due to the distortion aberration. As a result, the image as indicated by a solid line D in FIG. 4A is obtained.

To correct such distortion aberration, the distortion correction processing chip 26 may decrease the aberration quantity p included in the image signal V (r), which has been obtained from the pixel provided at the position corresponding to the image height r, to bring the aberration quantity p to be close to zero, as illustrated in FIG. 4C. That is, the distortion correction processing circuit 26 may bring the position r of the image signal V (r) to be close to the ideal position r′.

As a result of such correction processing, the distortion aberration is corrected and an image T that approximates an ideal image T′ can be obtained, as illustrated in FIG. 4D.

The image including the barrel-shaped distortion aberration is illustrated in FIG. 4A, but, practically, pincushion-shaped distortion aberration may occur, or mixed distortion aberration of the barrel distortion and pincushion-shaped distortion may occur. As mentioned above, even when such distortion aberration has occurred, the distortion correction processing chip 26 may bring the position r of the image signal V (r) to be close to the ideal position r′.

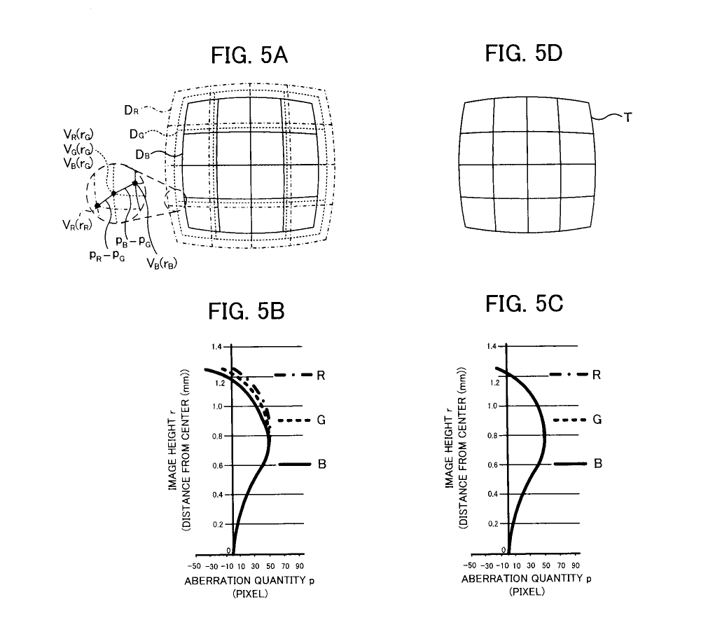

Next, magnification chromatic aberration and correction of the magnification chromatic aberration will be described by referring to FIGS. 5A to 5D. FIG. 5A is a schematic view illustrating an exemplary image in which the magnification chromatic aberration has occurred. FIG. 5B is a graph illustrating the position from the center of the pixel as a function of the aberration quantity included in the image signal obtained from each pixel and constituting an image having the magnification chromatic aberration occurred therein. FIG. 5C is a graph illustrating the position from the center of the pixel as a function of the aberration quantity included in an image signal obtained from each pixel and constituting an image after the magnification chromatic aberration has been corrected. FIG. 5D is a schematic view of an exemplary image in which the magnification chromatic aberration has been corrected.

When the magnification chromatic aberration occurs in the image according to the image signal output from the pixel unit 16, the image is multiplexed, as indicated by a dotted line D_{G}, a solid line D_{B}, and a dashed line D_{R} of FIG. 5A, instead of an image indicated by the dotted line D_{G} alone.

Such an image is formed as a result of the image signal, as illustrated in FIG. 5B, which has been obtained from the pixel provided at a position corresponding to the distance (image height) r from the center of the pixel unit 16, including aberration of the aberration quantity p, and the aberration quantity p being different for each color (that is, for each wavelength region). That is, in an ideal case where no magnification chromatic aberration has occurred, it is assumed that the image signals V_{B}(r_{G}), V_{G}(r_{C}), V_{R} (r_{G}) are obtained from the pixel provided at a position corresponding to the image height r_{G}, as illustrated in FIG. 5A. With the magnification chromatic aberration, however, the image signal of, for example, the blue component is obtained as the image signal V_{B}(r_{B}), which is shifted by the aberration quantity p_{B}-p_{G}, from the pixel provided at the position corresponding to the image height r_{B}. The image signal representing a red component is obtained as the image signal V_{R}(r_{R}), which is shifted by the aberration quantity p_{R}-p_{G}, from the pixel provided at the position corresponding to the image height r_{R}. Accordingly, a multiplexed image as illustrated in FIG. 5A is obtained.

To correct such magnification chromatic aberration, the distortion correction processing chip 26 may bring the difference in aberration quantity, which is included in the image signal for each color, to be close to zero, as illustrated in FIG. 5C. The image signal for each color is obtained from the pixel provided at the position of the distance (image height) r from the center of the pixel unit 16. That is, the distortion correction processing circuit 26 may bring the positions r_{R}, r_{G}, r_{B}, of the image signals of respective colors to be close to each other.

As a result of the correction processing, the magnification chromatic aberration is corrected and the image T with the multiplication suppressed can be obtained, as illustrated in FIG. 5D.

The distortion correction processing chip 26 thus corrects the distortion aberration and the magnification chromatic aberration as described above. The distortion correction processing chip 26 may correct both types of aberration one by one in this order. In the camera module 10, however, according to the present embodiment, the distortion correction processing chip 26 simultaneously corrects both the distortion aberration and the magnification chromatic aberration. The correction will be described below.

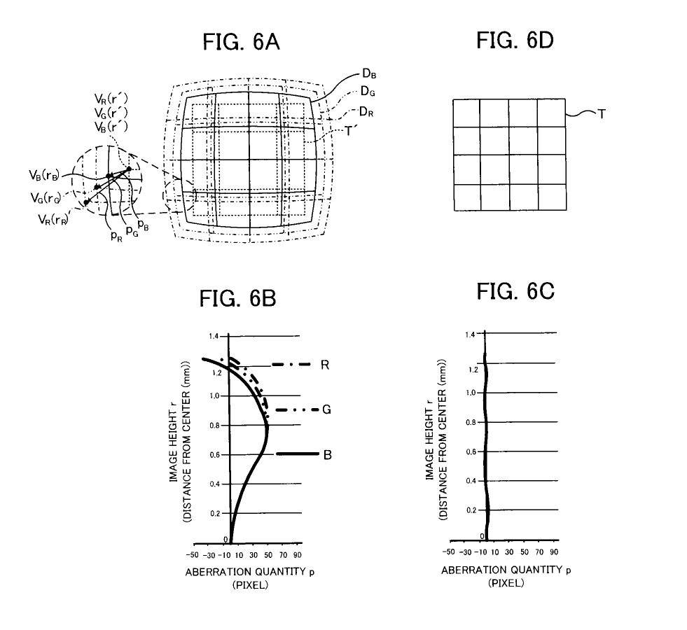

FIG. 6A is a schematic view illustrating an exemplary image in which the distortion aberration and the magnification chromatic aberration have occurred. FIG. 6B is a graph illustrating a position from the center of the pixel as a function of the aberration quantity included in the image signal obtained from each pixel and constituting an image having the distortion aberration and the magnification chromatic aberration occurred therein. FIG. 6C is a graph illustrating the position from the center of the pixel as a function of the aberration quantity included in an image signal obtained from each pixel and constituting an image after the distortion aberration and the magnification chromatic aberration have been corrected. FIG. 6D is a schematic view of an exemplary image in which the distortion aberration and the magnification chromatic aberration have been corrected.

When the distortion aberration and the magnification chromatic aberration occur in the image according to the image signal output from the pixel unit 16 of the solid state imaging device 1, the image is multiplexed and distorted in barrel shape, as indicated by the dashed line D_{R}, the two-dotted line D_{G}, and the solid line D_{B} of FIG. 6A, instead of an ideal image that reproduces the object as indicated by a dotted line T′.

Such an image is formed as a result of the image signal, which has been obtained for each color from the pixel provided at a position corresponding to the distance (image height) r from the center of the pixel unit 16, including aberration of the aberration quantity p that is different for each color, as illustrated in FIG. 6B. That is, in an ideal case where no distortion aberration and magnification chromatic aberration have occurred, it is assumed that the image signals V_{R}(r′), V_{G}(r′), V_{B} (r′) are obtained from the pixel provided at a position corresponding to the image height r′, as illustrated in FIG. 6A. Because of the distortion aberration and the magnification chromatic aberration, however, the image signal of the blue component is obtained as the image signal V_{B}(r_{B}), which is shifted by the aberration quantity p_{R}, from the pixel provided at the position corresponding to the image height r_{B}. The image signal representing the green component is obtained as the image signal V_{G} (r_{G}), which is shifted by the aberration quantity p_{G} from the pixel provided at the position corresponding to the image height r_{G}. The image signal of the red component is obtained as the image signal V_{R}(r_{R}), which is shifted by the aberration quantity p_{R}, from the pixel provided at the position corresponding to the image height r_{R}. Accordingly, multiplexed images with each image being distorted in barrel shape are obtained, as illustrated in FIG. 6A.

To correct such distortion aberration and magnification chromatic aberration, the distortion correction processing chip 26 may decrease the aberration quantities p_{R}, p_{G}, p_{B} included in the image signals obtained from the pixels at positions corresponding to the distance (image height) r_{R}, r_{G}, r_{B} from the center of the pixel unit 16, as illustrated in FIG. 6C. The aberration quantities p_{R}, p_{G}, p_{B} may be brought close to zero. That is, the distortion correction processing circuit 26 may bring the positions r_{R}, r_{G}, r_{B} of the image signals V_{R} (r_{R}), V_{G} (r_{G}), V_{B} (r_{B}), respectively, to be close to the ideal position r′.

As a result of the correction processing, the distortion aberration and the magnification chromatic aberration are corrected simultaneously, and the image T that approximates the ideal image T′ can be obtained, as illustrated in FIG. 6D.

Specific structure of the distortion correction processing chip 26 will be described later.

Referring to FIG. 3, after the distortion aberration and the magnification chromatic aberration have been corrected in the distortion correction processing chip 26, an image signal having undergone various types of signal processing is output from the distortion correction processing chip 26. The image formed according to the image signal becomes an excellent image, as illustrated in FIG. 6D, in which both the blur aberration and the distortion aberration have been corrected and the variation of pixel characteristics is suppressed.

In the camera module 10 according to the present embodiment, the image signal output from the solid state imaging device 1 is sent to a controller 31, such as a central processing unit (CPU), installed in an electric device of a mobile phone or the like in which the camera module 10 is mounted.

The controller 31 determines if there is a blur in the image formed according to the image signal output from the solid state imaging device 1.

If no blur has been generated, the image having been formed according to the image signal output from the solid state imaging device 1 is provided as an output image of the camera module 10.

While the blur has been generated, the AF driver 25 is driven according to the blur quantity to flow a predetermined amount of electric current to the coil 23 that acts as the lens driving unit. The lens 11 is then moved to a position where the blur in the image is suppressed. As a result, the image in which the blur has been suppressed can be provided as an output image of the camera module 10.

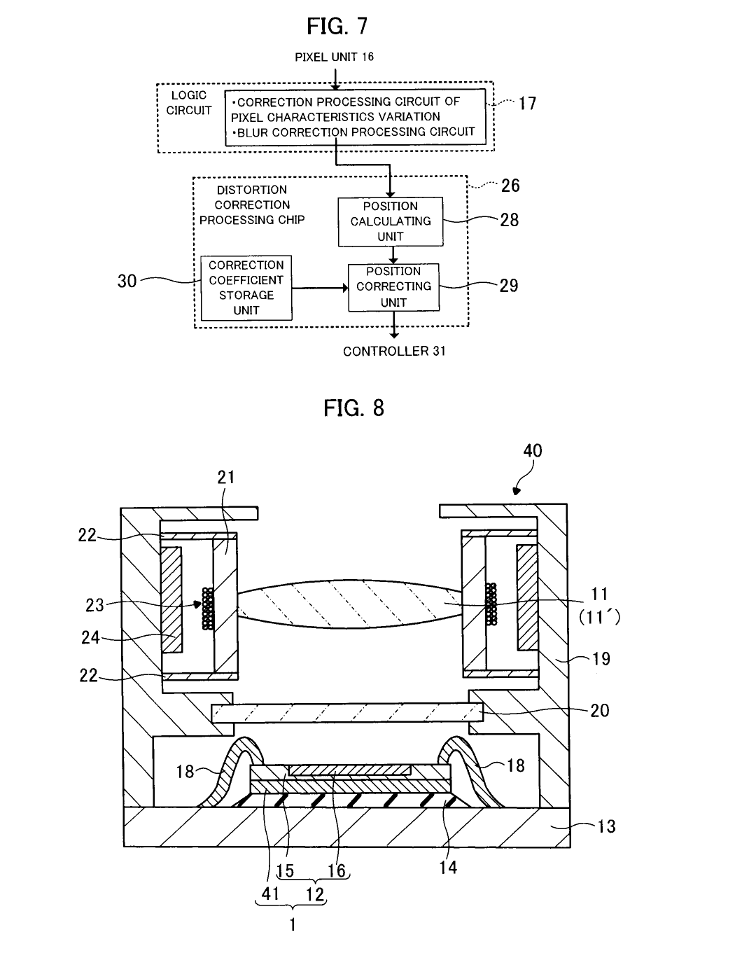

Next, the distortion correction processing chip will be described. FIG. 7 is a block diagram illustrating the distortion correction processing chip 26 and the logic circuit 17. As illustrated in FIG. 7, the logic circuit 17 includes the correction processing circuit of pixel characteristics variation and the blur correction processing circuit.

The distortion correction processing chip 26 includes a position calculating unit 28 configured to calculate a position of the pixel from which the image signal has been obtained, and a position correcting unit 29 configured to calculate the position of the obtained image signal after the correction has been performed.

The position calculating unit 28 calculates, for example, a distance r between the center of the pixel unit 16 and the pixel position where the image signal has been obtained.

The position correcting unit 29 performs correction to decrease the aberration quantity p included in the image signal obtained in the pixel provided at the distance r from the center, and brings the actually obtained position of the image signal close to an ideal position where the image signal is to be obtained. That is, the position correcting unit performs correction to bring a curve representing the aberration quantity as indicated by FIG. 6B, to be close to a straight line as indicated in FIG. 6C. The position correcting unit 29 calculates a post-correction position as a distance r′ from the center of the pixel unit.

The position correcting unit 29 calculates the distance r′ representing the post-correction position using the distance r representing a pre-correction position according to, for example, a polynominal equation below.

r′=A×r⁹+B×r⁷+C×r⁵+D×r³+E×r

The distortion correction processing chip 26 includes a correction coefficient storage unit 30 that stores coefficients A, B, C, D, E of the above polynominal equation. Upon receipt of the distance r calculated by the position calculating unit 28, the position correcting unit 29 reads coefficients A, B, C, D, E of the polynominal equation from the correction coefficient storage unit 30. The position correcting unit 29 then sets the distance r and the coefficients A, B, C, D, E in the polynominal equation to calculate the post-correction position of the image signal as the distance r′ from the center of the pixel unit 16.

The distortion correction processing chip 26 thus corrects the position of the image signal. As a result, the distortion of the image formed according to the image signal output from the distortion correction processing chip 26 is corrected.

As illustrated in FIG. 6B, the image signal includes different aberration quantities for each color. The coefficients A, B, C, D, E used in calculation of the distance r′ by the position correcting unit 29 are also different for each color. Ideally, therefore, the correction coefficient storage unit 30 may store a group of coefficients suitable for each color (A_{B}, B_{B}, C_{B}, D_{B}, E_{B}), (A_{G}, B_{G}, C_{G}, D_{G}, E_{G}), (A_{R}, B_{R}, C_{R}, D_{R}, E_{R}), such that the group of coefficients corresponding to the color of the image signal is read when the position correcting unit 29 calculates the distance r′.

Since, however, the actual difference of the aberration quantity between colors is small, the distance r′ may be calculated using the same coefficients A, B, C, D, E. Accordingly, the storage area of the correction coefficient storage unit 30 can be saved.

As described above, in the camera module 10 of the present embodiment, the solid state imaging device 1 includes the distortion correction processing chip 26 to correct the distortion aberration and the magnification chromatic aberration of the image output from the camera module 10. In the camera module 10 to which the solid state imaging device 1 mentioned above has been applied, there is no need to provide a lens for correcting the aberration. As a result, the number of lenses provided in the lens barrel 21 can be reduced, to thereby decrease the size of the camera module 10. The distortion correction processing chip 26 is arranged in an unused area on the surface of the substrate 13 around the solid state imaging chip 12. Enlargement of the size of the camera module 10 due to providing the distortion correction processing chip 26 can, therefore, be suppressed.

Meanwhile, the camera module 10 according to the first embodiment can also be used as a camera module for taking motion pictures, because it is not necessary to execute signal processing of correcting the lens aberration externally, for example, on software outside the module 10.

### Second Embodiment

FIG. 8 is a sectional view of a camera module according to a second embodiment. In a camera module 40 illustrated in FIG. 8, the position where the distortion correction processing chip is arranged is different when compared to the camera module 10 of the first embodiment. In the camera module 40 according to the second embodiment, a distortion correction processing chip 41 is provided on the surface of the substrate 13 so as to be in contact with the lower surface of the solid state imaging chip 12 (lower surface of the semiconductor substrate 15). That is, the distortion correction processing chip 41 is arranged on the surface of the substrate 13, and the solid state imaging chip 12 is arranged on the surface of the distortion correction processing chip 41.

In the camera module 40 according to the second embodiment, the solid state imaging device 1 also includes the distortion correction processing chip 41. The lens for correcting the distortion aberration and the magnification chromatic aberration is not necessary. As a result, the number of lenses arranged in the lens barrel 21 can be reduced, to thereby decrease the size of the camera module 40. The distortion correction processing chip 41 is arranged between the solid state imaging chip 12 and the substrate 13. Enlargement of the size of the camera module 40 due to providing the distortion correction processing chip 41 can be suppressed.

Further, in the camera module 40 according to the second embodiment, the distortion correction processing chip 41 is arranged between the solid state imaging chip 12 and the substrate 13, instead of being arranged on the surface of the substrate 13 around the solid state imaging chip 12. It is possible, therefore, to eliminate space to arrange the distortion correction processing circuit 41, when compared to the camera module 10 of the first embodiment, to thereby decrease the size of the camera module 40.

Meanwhile, the camera module 40 according to the second embodiment can also be used as a camera module for taking motion pictures, because it is not necessary to execute signal processing of correcting the lens aberration externally, for example, on software outside the module 40.

In the camera module 10 of the first embodiment and the camera module 40 of the second embodiment, both the distortion correction processing chips 26, correct the distortion aberration and the magnification chromatic aberration. Alternatively, the distortion correction processing chip may correct one of the distortion aberration and the magnification chromatic aberration, and the other aberration is corrected by a lens. Such embodiments will be described below.

### Third Embodiment

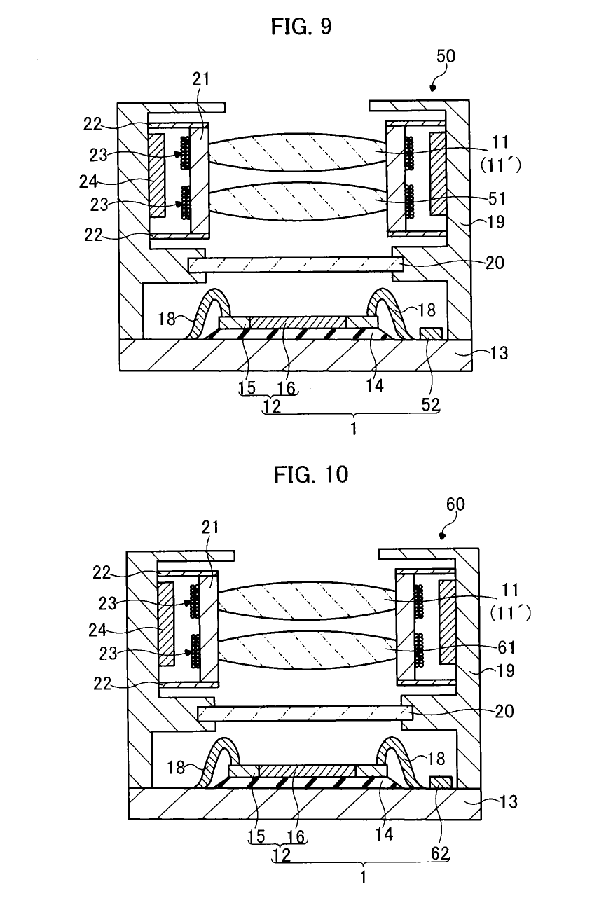

FIG. 9 is a sectional view illustrating a camera module according to a third embodiment. A camera module 50 illustrated in FIG. 9 is different from the camera module 10 of the first embodiment in that a distortion correction processing chip 52 corrects the distortion aberration alone. The camera module 50 is also different from the camera module 10 of the first embodiment in that a lens 51 for correcting the magnification chromatic aberration is additionally provided in the lens barrel 21.

In such a camera module 50 according to the third embodiment, the solid state imaging device 1 also includes the distortion correction processing unit 52 that corrects the distortion aberration. The lens for correcting the distortion aberration is not necessary. As a result, the number of lenses provided in the lens barrel 21 can be reduced, when compared to the camera module in the past, to thereby decrease the size of the camera module 50. The distortion correction processing chip 52 is arranged in an unused area on the surface of the substrate 13 around the solid state imaging chip 12. Enlargement of the size of the camera module 50 due to providing the distortion correction processing chip 52 can be suppressed.

Meanwhile, the camera module 50 according to the third embodiment can also be used as a camera module for taking motion pictures, because it is not necessary to execute signal processing of correcting the lens aberration externally, for example, on software outside the module 50.

### Fourth Embodiment

FIG. 10 is a sectional view illustrating a camera module according to a fourth embodiment. A camera module 60 illustrated in FIG. 10 is different from the camera module 10 of the first embodiment in that a distortion correction processing chip 62 corrects the magnification chromatic aberration alone. The camera module 60 is also different from the camera module 10 of the first embodiment in that an additional lens 61 for correcting the distortion aberration is provided in the lens barrel 21.

In such a camera module 60 according to the fourth embodiment, a distortion correction processing chip 62 that corrects the magnification chromatic aberration is also included in the solid state imaging device 1. The lens for correcting the magnification chromatic aberration is not necessary. As a result, the number of lenses provided in the lens barrel 21 can be reduced, when compared to the camera module in the past, to thereby decrease the size of the camera module 60. The distortion correction processing chip 62 is arranged in an unused area on the surface of the substrate 13 around the solid state imaging chip 12. Enlargement of the size of the camera module 60 due to providing the distortion correction processing chip 62 can be suppressed.

Meanwhile, the camera module 60 according to the fourth embodiment can also be used as a camera module for taking motion pictures, because it is not necessary to execute signal processing of correcting the lens aberration externally, for example, on software outside the module 60.

In the camera module 50 according to the third embodiment and the camera module 60 according to the fourth embodiment, the distortion correction processing chips 52, 62 may be arranged between the solid state imaging chip 12 and the substrate 13, as in the camera module 40 according to the second embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

In the embodiments described above, the distortion correction processing circuits 26, 41, 52, 62 have been applied to the camera modules 10, 40, 50, 60. However, the distortion correction processing chips 26, 41, 52, 62 can also be similarly applied to other imaging modules including the lens 11.

What is claimed is:

1. A camera module, comprising:
a blur correcting lens;
a lens holder arranged on a mounting substrate, the lens holder including the blur correcting lens inside the lens holder;
a solid state imaging chip including a logic circuit and a pixel unit which has a plurality of pixels, the solid state imaging chip arranged on the mounting substrate or above the mounting substrate so as to be covered by the lens holder; and
a distortion correction processing chip arranged on the mounting substrate inside the lens holder, the distortion correction processing chip correcting an image signal output from the solid state imaging chip in such a manner that distortion of the image formed by the image signal is corrected.

2. The camera module according to claim 1, wherein
the distortion correction processing chip is arranged on the mounting substrate around the solid state imaging chip.

3. The camera module according to claim 1, wherein
the distortion correction processing chip is arranged on the mounting substrate, and
the solid state imaging chip is arranged on the distortion correction processing chip.

4. The camera module according to claim 1, wherein
a distortion correcting lens is not provided in the camera module.

5. The camera module according to claim 4, wherein
the distortion correcting lens is configured to correct distortion aberration or magnification chromatic aberration.

6. The camera module according to claim 4, wherein
the distortion correction processing chip is configured to correct the distortion aberration and the magnification chromatic aberration, and
the distortion correcting lens is configured to correct the distortion aberration and the magnification chromatic aberration.

7. The camera module according to claim 4, wherein
the distortion correction processing chip is configured to correct the distortion aberration, and
the distortion correcting lens is configured to correct the distortion aberration.

8. The camera module according to claim 7, wherein
the lens holder further includes therein a lens configured to correct the magnification chromatic aberration inside the lens holder.

9. The camera module according to claim 4, wherein
the distortion correction processing chip is configured to correct the magnification chromatic aberration, and
the distortion correcting lens is configured to correct the magnification chromatic aberration.

10. The camera module according to claim 9, wherein
the lens holder further includes a lens that corrects the distortion aberration inside the lens holder.

11. The camera module according to claim 1, wherein
the blur correcting lens is configured to correct one of spherical aberration, coma aberration, astigmatism, and field curvature.

12. The camera module according to claim 11, wherein
the logic circuit is configured to correct aberration not corrected by the blur correcting lens among the spherical aberration, the coma aberration, the astigmatism, and the field curvature.

13. The camera module according to claim 12, wherein
the logic circuit further includes a correction processing circuit of pixel characteristics variation configured to correct the image signal in such a manner that a variation of pixel characteristics of the plurality of pixels is suppressed.

14. The camera module according to claim 1, wherein
the distortion correction processing chip includes
a position calculating unit configured to calculate a position where the image signal is obtained, and
a position correcting unit configured to correct the position calculated by the position calculating unit.

15. The camera module according to claim 14, wherein
the distortion correction processing chip further includes a correction coefficient storage unit configured to store a correction coefficient for correcting the position calculated by the position calculating unit, and
the position correcting unit is configured to correct the position using the position calculated by the position calculating unit and the correction coefficient stored in the correction coefficient storage unit.
